(19) United States
(12) Patent Application Publication
(10) Pub. No.: US 2013/0272024 A1
(43) Pub. Date: Oct. 17, 2013

(54) DIFFUSION STRUCTURE AND LIGHTING DEVICE WITH SUCH DIFFUSION STRUCTURE

(71) Applicant: MING TANG YAO, New Taipei City (TW)

(72) Inventor: MING TANG YAO, New Taipei City (TW)

(73) Assignee: E-LON OPTRONICS CO., LTD., New Taipei City (TW)

(21) Appl. No.: 13/530,325

(22) Filed: Jun. 22, 2012

(30) Foreign Application Priority Data
Apr. 13, 2012 (TW) 101113344

(51) Int. Cl. F21V 11/00; F21V 8/00

(52) U.S. Cl. 362/608; 362/235; 362/355

(57) ABSTRACT

A diffusion structure and a lighting device with the diffusion structure are provided. The diffusion structure includes a first surface and a second surface. A speckle layer is formed on the first surface. A grating layer is formed on the second surface. The grating layer is arranged between a light source and the speckle layer. Consequently, plural light beams emitted by the light source are sequentially transmitted through the grating layer and the speckle layer and then outputted to surroundings.

### FIELD OF THE INVENTION

The present invention relates to a diffusion structure, and more particularly to a diffusion structure for use in a lighting device.

### BACKGROUND OF THE INVENTION

In recent years, light emitting diodes (LEDs) are widely used in daily lives because of many benefits and advantages such as power-saving efficacy. Until now, LEDs are widely used in many electronic devices such as display devices, household electrical appliances, vehicle electronic components, lighting devices, and the like. Take a household lighting device using the LED as the lighting device for example. In comparison with the conventional incandescent lights and fluorescent lamps, LED has shorter warm-up time, quicker response speed, smaller size, longer life, higher power-saving efficacy, better shock resistance, lower contamination, higher reliability and higher productivity. With the maturity of the LED technology, LEDs will replace the conventional incandescent lights and fluorescent lamps.

In comparison with the conventional light source, LED has higher directivity. Due to the good directivity, when plural LEDs are enabled to emit light beams simultaneously, the user usually feels that the light beams are from plural “points”. Under this circumstance, the user usually feels uncomfortable. For solving this problem, the lighting device using LEDs as the light sources is usually equipped with a diffusion plate. The light beams from all LEDs are firstly incident to the diffusion plate and then outputted to the surroundings. Since plural microstructures, frosted structures, diffusion powder (such as titanium dioxide) or irregular particles are formed on the surface of the diffusion plate, the lighting device has the “planar” lighting efficacy. The “planar” lighting efficacy of using the diffusion plate is well-known in the art, and is not redundantly described herein.

Nowadays, the manufacturers pay much attention to the performance development of the diffusion plates according to two mainstream aspirations. The first aspiration is related to the transmittance of the diffusion plate, i.e. the capability of allowing the light beams from the LED to penetrate through the diffusion plate. The transmittance of the diffusion plate has an influence on the luminance provided by the lighting device. The second aspiration is related to the haze of the diffusion plate, i.e. the capability of converting the “point” illumination to the “planar” illumination. However, for most of the current diffusion plates, the transmittance is negatively correlated with the haze. It is very difficult to increase the transmittance and the haze simultaneously. Moreover, for most of the current diffusion plates, the light diffusion angle is usually restricted to be smaller than 120 degrees. As known, the structure and fabricating process of the current diffusion plate are not effective to increase the light diffusion angle.

Therefore, there is a need of providing an approach to improve the diffusion plate.

### SUMMARY OF THE INVENTION

The present invention relates to a diffusion structure, and more particularly to a diffusion structure with high transmittance, high haze and wide light diffusion angle.

The present invention further provides a lighting device with such a diffusion structure.

In accordance with an aspect of the present invention, there is provided a lighting device. The lighting device includes at least one LED unit and a diffusion structure. The at least one LED unit is used for emitting plural light beams. The diffusion structure is arranged in a transmission path of the plural light beams. The diffusion structure includes a grating layer and a speckle layer. The plural light beams are sequentially transmitted through the grating layer and the speckle layer and then outputted to surroundings.

In an embodiment, the grating layer is arranged between the at least one LED unit and the speckle layer.

In an embodiment, the speckle layer and the grating layer are formed on a first surface and a second surface of the diffusion structure, respectively.

In an embodiment, the grating layer includes plural gratings, which are partially or entirely distributed over the second surface, wherein any two of the gratings have an identical grating parameter set or different grating parameter sets.

In an embodiment, the grating parameter set includes at least one of a grating depth, a grating pitch, a grating duty cycle and a grating orientation. After the plural light beams are transmitted through the speckle layer and then outputted to surroundings, the plural light beams collectively result in a light pattern. In addition, the light pattern is determined according to the grating parameter sets of the plural grating and/or a distribution status of the plural gratings.

In an embodiment, the speckle layer further includes at least one functional region and the at least one functional region has a specified profile without any speckle, or the speckle layer is partially or entirely distributed over the first surface and at least comprises plural speckles. The plural speckles are continuously distributed over the first surface, or the plural speckles are discontinuously distributed over the first surface, or the plural speckles are distributed as a specified profile, wherein any two of the plural speckles have an identical intensity, or any two of the plural speckles have different intensities.

In an embodiment, the grating layer is formed on the diffusion structure by at least one of a holographic lithography technology, an electronic etching technology, a laser beam writing technology, a phase mask lithography technology, a micro-molding technology and a holographic technology.

In an embodiment, the lighting device is a bottom-lighting type lighting device.

In an embodiment, the lighting device further includes a lateral light source processing module and a light guide module. At least one saw-toothed structure is formed on a second surface of the lateral light source processing module. In addition, an included angle between a surface of the at least one saw-toothed structure and a normal line perpendicular to a first surface of the lateral light source processing module is a specified angle. When at least one light beam is projected on the at least one saw-toothed structure, the at least one light beam is reflected by the at least one saw-toothed structure and propagated along a specified direction, so that the at least one light beam is transmitted through the first surface of the lateral light source processing module and directed to the diffusion structure. The light guide module is arranged between the at least one LED unit and the lateral light source processing module, or the at least one LED unit is arranged between the lateral light source processing module and the light guide module. In addition, at least one of the plural light beams from the at least one LED unit is guided to the at least one saw-toothed structure by the light guide module.

In an embodiment, the specified angle is in a range between 40 degrees and 45 degrees.

In an embodiment, the diffusion structure further includes an image piece, and the speckle layer is arranged between the grating layer and the image piece. The plural light beams from the at least one LED unit are sequentially transmitted through the grating layer, the speckle layer and the image piece and then outputted to surroundings.

In accordance with another aspect of the present invention, there is provided a diffusion structure for uniformly diffusing plural light beams and outputting the plural light beams to surroundings. The diffusion structure includes a first surface and a second surface. The second surface opposed to the first surface. A speckle layer is formed on the first surface. A grating layer is formed on the second surface. The grating layer is arranged between a light source and the speckle layer, so that the plural light beams emitted by the light source are sequentially transmitted through the grating layer and the speckle layer and then outputted to surroundings.

In an embodiment, the grating layer includes plural gratings, which are partially or entirely distributed over the second surface, wherein any two of the gratings have an identical grating parameter set or different grating parameter sets.

In an embodiment, the grating parameter set includes at least one of a grating depth, a grating pitch, a grating duty cycle and a grating orientation. After the plural light beams are transmitted through the speckle layer and then outputted to surroundings, the plural light beams collectively result in a light pattern. In addition, the light pattern is determined according to at least one of the grating parameter sets of the plural grating and a distribution status of the plural gratings.

In an embodiment, the grating layer is formed on the diffusion structure by at least one of a holographic lithography technology, an electronic etching technology, a laser beam writing technology, a phase mask lithography technology, a micro-molding technology and a holographic technology.

In an embodiment, the speckle layer further includes at least one functional region and the at least one functional region has a specified profile without any speckle, or the speckle layer is partially or entirely distributed over the first surface and at least comprises plural speckles. The plural speckles are continuously distributed over the first surface, or the plural speckles are discontinuously distributed over the first surface, or the plural speckles are distributed as a specified profile, wherein any two of the plural speckles have an identical intensity, or any two of the plural speckles have different intensities.

In an embodiment, the diffusion structure is included in an indoor lighting device, an outdoor lighting device, a display device, a backlight module or a projecting device, or the light source comprises at least one LED unit.

In an embodiment, the indoor lighting device or the outdoor lighting device includes a lateral light source processing module and a light guide module. At least one saw-toothed structure is formed on a second surface of the lateral light source processing module. In addition, an included angle between a surface of the at least one saw-toothed structure and a normal line perpendicular to a first surface of the lateral light source processing module is a specified angle. When at least one light beam is projected on the at least one saw-toothed structure, the at least one light beam is reflected by the at least one saw-toothed structure and propagated along a specified direction, so that the at least one light beam is transmitted through the first surface of the lateral light source processing module and directed to the diffusion structure. The light guide module is arranged between the at least one LED unit and the lateral light source processing module, or the at least one LED unit is arranged between the lateral light source processing module and the light guide module. In addition, at least one of the plural light beams from the at least one LED unit is guided to the at least one saw-toothed structure by the light guide module.

In an embodiment, the specified angle is in a range between 40 degrees and 45 degrees.

In an embodiment, the diffusion structure further includes an image piece. The speckle layer is arranged between the grating layer and the image piece. The plural light beams from the light source are sequentially transmitted through the grating layer, the speckle layer and the image piece and then outputted to surroundings.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a diffusion structure according to a first embodiment of the present invention;

FIG. 2A schematically illustrates the distribution of plural point light sources formed by a single point light, in which the grating has a grating depth D1 and a grating pitch T1;

FIG. 2B schematically illustrates the distribution of plural point light sources formed by a single point light, in which the grating has a grating depth D2 and a grating pitch T1;

FIG. 2C schematically illustrates the distribution of plural point light sources formed by a single point light, in which the grating has a grating depth D2 and a grating pitch T2;

FIG. 3A schematically illustrates the light pattern resulted from the orthogonal interference of plural light beams that are transmitted through the grating layer;

FIG. 3B schematically illustrates the light pattern resulted from the interference of plural light beams that are transmitted through the grating layer at a 60-degree interference angle;

FIG. 4 schematically illustrates a bottom-lighting type lighting device having the diffusion structure of FIG. 1;

FIG. 5 schematically illustrates a lateral-lighting type lighting device having the diffusion structure of FIG. 1;

FIG. 6 schematically illustrates another lateral-lighting type lighting device having the diffusion structure of FIG. 1;

FIG. 7 is a schematic front view illustrating an exemplary speckle layer used in a diffusion structure according to a second embodiment of the present invention;

FIG. 8 is a schematic front view illustrating an exemplary speckle layer used in a diffusion structure according to a third embodiment of the present invention; and

FIG. 9 is a schematic front view illustrating some components of a diffusion structure according to a fourth embodiment of the present invention.

### DETAILED DESCRIPTION OF THE PREFERRED EMBODIMENT

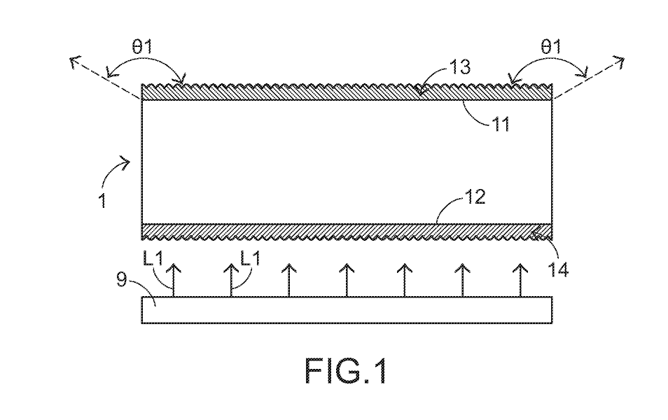

FIG. 1 is a schematic side view illustrating a diffusion structure according to a first embodiment of the present invention. As shown in FIG. 1, the diffusion structure 1 comprises a first surface 11 and a second surface 12, wherein the first surface 11 and the second surface 12 are opposed to each other. A speckle layer 13 is formed on the first surface 11. A grating layer 14 is formed on the second surface 12. In addition, the grating layer 14 is arranged between a light source 9 and the speckle layer 13. Consequently, plural light beam L1 emitted by the light source 9 are sequentially transmitted through the grating layer 14 and the speckle layer 13 and then outputted to the surroundings.

Moreover, the grating layer 14 comprises plural gratings, and the speckle layer 13 comprises plural speckles. In a preferred embodiment, the speckles are distributed over the entire first surface 11, and the gratings are distributed over the entire second surface 12. The ways of distributing the speckles and the gratins are presented herein for purpose of illustration and description only. However, those skilled in the art will readily observe that numerous modifications and alterations may be made according to the practical requirements. For example, the speckles may be only distributed over a part of first surface 11, and the gratings may be only distributed over a part of the second surface 12. Moreover, the gratings or the speckles may be distributed in a continuous or discontinuous manner.

Furthermore, the grating layer 14 may be formed on the diffusion structure 1 by any one of a holographic lithography technology, an electronic etching technology, a laser beam writing technology, a phase mask lithography technology, a micro-molding technology and a holographic technology.

In this embodiment, the main body 1 of the diffusion structure 1 is a flat plate. The light source 9 is composed of plural light emitting diode units (not shown). Alternatively, the light source 9 is composed of plural laser units (not shown). Moreover, in this embodiment, the light source 9 is a bottom-lighting type light source for directly projecting the plural light beams L1 to the diffusion structure 1. The light source is presented herein for purpose of illustration and description only. However, those skilled in the art will readily observe that numerous modifications and alterations may be made according to the practical requirements.

The spirits and diffusing principles of the diffusion structure of the present invention will be illustrated as follows. When the plural light beams L1 emitted by the light source 9 are projected on the grating layer 14, the plural light beams L1 are diffracted and scattered by the gratings of the grating layer 14. Under this circumstance, the original plural “point” light sources formed by the plural light beams L1 are converted into more “point” light sources. Consequently, after these light beams L1 are transmitted through the grating layer 14, the overall light beams L1 exhibits a visual effect like a start-studded sky. In other words, these “point” light sources are collaboratively defined as a “planar” light source.

However, since these light beams L1 are subject to color dispersion on the gratings of the grating layer 14, the visual effect like the start-studded sky is a polychromatic effect (e.g. a rainbow-like colorful effect). After the colors of the light beams L1 are dispersed, the color-dispersed light beams L1 are projected to the speckle layer 13. The speckles of the speckle layer 13 provide a function of mixing the color-dispersed light beams L1. Consequently, the light beams outputted to the surroundings are uniformly mixed white light.

It is noted that each grating of the grating layer 14 has a corresponding grating parameter set. The grating parameter set includes at least one of a grating depth, a grating pitch, a grating duty cycle and a grating orientation. By controlling the grating parameter set of each grating of the diffusion structure 1, the light diffusion angle, the diffusion area, the light pattern and the light diffraction efficiency are adjustable.

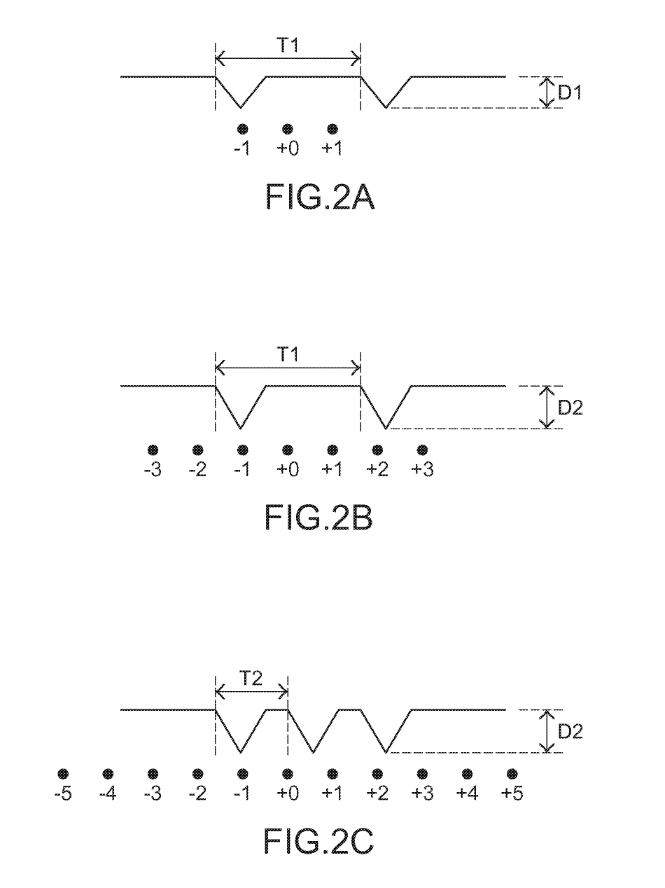

Hereinafter, the distribution of plural point light sources formed by a single point light source in response to plural gratings will be illustrated with reference to FIGS. 2A-2C. In FIG. 2A, the diffraction efficiency for the grating with a grating depth D1 and a grating pitch T1 is shown. That is, for the grating with the grating depth D1 and the grating pitch T1, the single point light may result in the distribution of plural point light sources at the diffraction orders −1, 0 and 1. In FIG. 2B, the diffraction efficiency for the grating with a grating depth D2 and the grating pitch T1 is shown, wherein the grating depth D2 is greater than the grating depth D1. That is, for the grating with the grating depth D2 and the grating pitch T1, the single point light may result in the distribution of plural point light sources at the diffraction orders −3, −2, −1, 0, 1, 2 and 3. In FIG. 2C, the diffraction efficiency for the grating with the grating depth D2 and a grating pitch T2 is shown, wherein the grating pitch T2 is smaller than the grating pitch T1. That is, for the grating with the grating depth D2 and the grating pitch T2, the single point light may result in the distribution of plural point light sources at the diffraction orders −5, −4, −3, −2, −1, 0, 1, 2, 3, 4 and 5. Moreover, for the grating having a proper grating depth and the grating pitch, all of the point light sources have the identical brightness value. Moreover, the brightness values of the point light sources at various orders may be adjusted according to the practical requirements. In these drawings, the size of the point light source is presented herein for purpose of illustration and description only. It is noted that the brightness values of the point light sources may be identical or different.

Moreover, by controlling the grating parameter set of each grating and/or controlling the distribution status of these gratings, after the plural light beams are transmitted through the grating layer, the plural light beams are interfered with each other to collectively result in a light pattern.

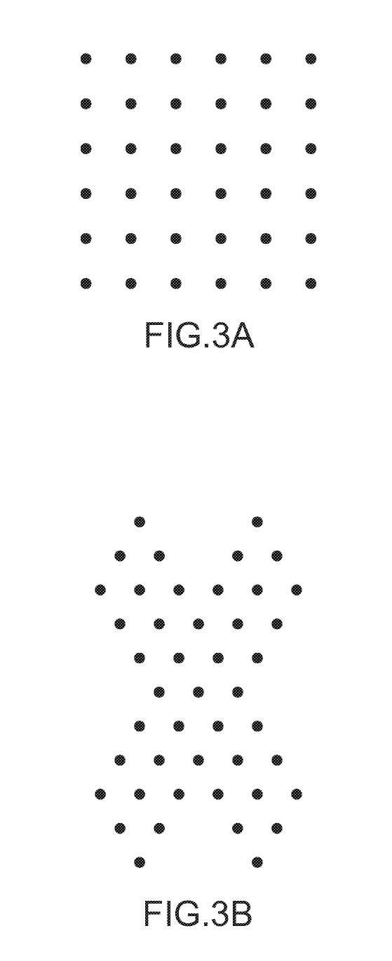

Hereinafter, the light pattern resulted from the interference of plural light beams that are transmitted through the grating layer will be illustrated with reference to FIGS. 3A and 3B. FIG. 3A schematically illustrates the light pattern resulted from the orthogonal interference of plural light beams that are transmitted through the grating layer. Due to the orthogonal interference, the plural light beams collectively result in a square light pattern. FIG. 3B schematically illustrates the light pattern resulted from the interference of plural light beams that are transmitted through the grating layer at a 60-degree interference angle. Consequently, the plural light beams collectively result in an X-shaped light pattern.

Consequently, those skilled in the art will readily observe that the grating layer 14 may be designed according to the practical specification requirements of the diffusion structure 1. That is, any two gratings of the grating layer 14 may have an identical grating parameter set or different grating parameter sets.

Moreover, by controlling the roughness of the first surface 11 of the diffusion structure 1, the speckle intensity of the speckle layer 13 is changed, so that the light mixing effect of the speckle layer 13 is adjustable. That is, any two speckles of the speckle layer 13 may have the identical speckle intensity or different speckle intensities.

From the above discussions, for the diffusion structure 1 of the present invention, the transmittance is 80%, the haze is 100%, and the light diffraction angle θ1 is 170. Since the diffusion structure 1 of the present invention is effective to solve the drawbacks of the conventional diffusion structure, the diffusion structure 1 of the present invention has industrial usefulness in the lighting technology. For example, the diffusion structure 1 of the present invention may be applied to a lighting device such as a wall lamp, an advertising lamp, a lamp cover, or the like. Alternatively, the diffusion structure 1 of the present invention may be applied to a backlight module (e.g. a LCD display device) or a projecting device.

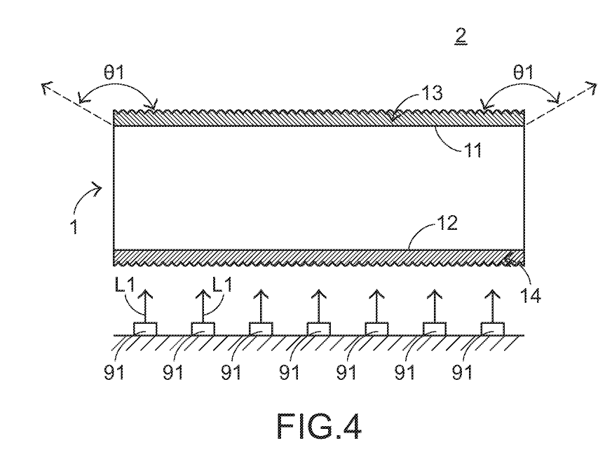

FIG. 4 schematically illustrates a bottom-lighting type lighting device having the diffusion structure of FIG. 1. The bottom-lighting type lighting device 2 is an indoor lighting device or an outdoor lighting device. As shown in FIG. 4, the bottom-lighting type lighting device 2 comprises plural LED units 91 and the diffusion structure 1. Since the diffusion structure 1 of the present invention is effective to increase the light diffraction angle, the bottom-lighting type lighting device 2 may be applied to a street light. Consequently, the spacing interval between any two adjacent street lights may be increased in order to reduce the number of the street lights.

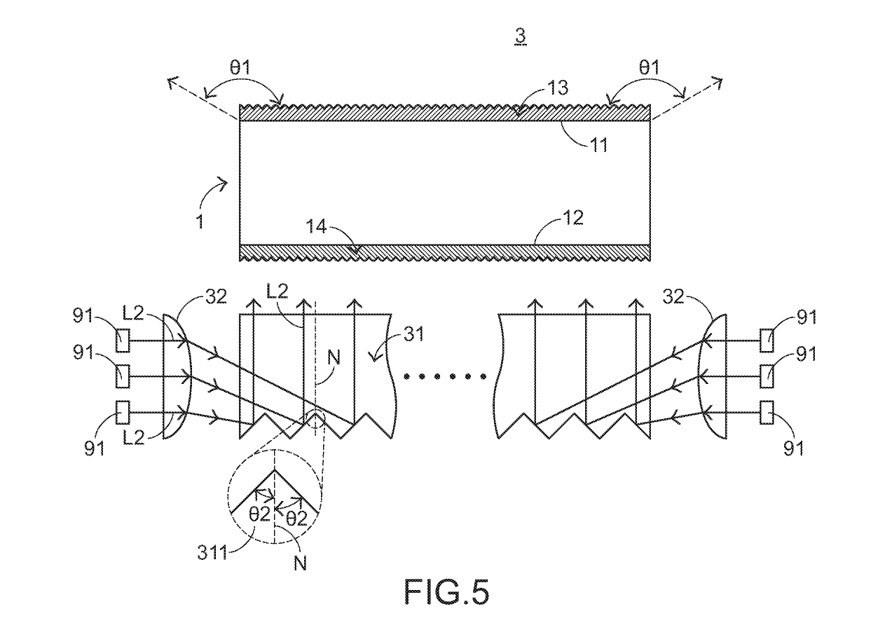

FIG. 5 schematically illustrates a lateral-lighting type lighting device having the diffusion structure of FIG. 1. The lateral-lighting type lighting device 3 is an indoor lighting device or an outdoor lighting device. As shown in FIG. 5, the lateral-lighting type lighting device 3 comprises plural LED units 91, a lateral light source processing module 31, a light guide module 32, and the diffusion structure 1. These LED units 91 are located at the lateral edges of the lateral light source processing module 31. Moreover, plural saw-toothed structures 311 are formed on a second surface of the lateral light source processing module 31. The light guide module 32 is arranged between the plural LED units 91 and the lateral light source processing module 31. By the light guide module 32, the light beams L2 emitted by the plural LED units 91 are projected to the saw-toothed structures 311. Preferably, the light guide module 32 comprises at least one of a semi-cylindrical lens, a micro structure and an optical element.

Moreover, as shown in FIG. 5, there is an included angle θ2 between any surface of any saw-toothed structure 311 and a normal line N perpendicular to a first surface of the lateral light source processing module 31. Due to the included angle θ2, when the plural light beams L2 emitted by the plural LED units 91 are projected on any saw-toothed structure 311, the plural light beams L2 are reflected by the saw-toothed structures 311 and propagated along a specified direction. Those skilled in the art will readily observe that the included angle θ2 may be designed according to the practical requirements. Consequently, the propagating direction of the reflected light beams L2 from the saw-toothed structures 311 can be controlled.

In this embodiment, the included angle θ2 is a specified angle. The specified angle is in the range between 40 degrees and 45 degrees. Consequently, when the plural light beams L2 emitted by the plural LED units 91 are projected on any saw-toothed structure 311, the plural light beams L2 are reflected by the saw-toothed structures 311, then transmitted through the second surface of the lateral light source processing module 31, and finally directed to the grating layer 14 of the diffusion structure 1.

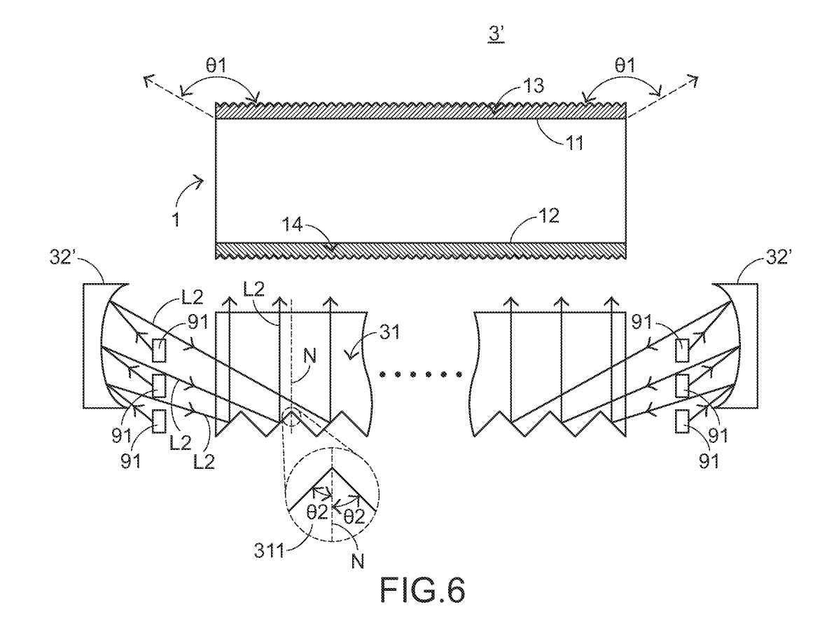

FIG. 6 schematically illustrates another lateral-lighting type lighting device having the diffusion structure of FIG. 1. Except for the following items, the configurations of the lateral-lighting type lighting device 3′ are substantially identical to those of the lateral-lighting type lighting device of FIG. 5, and are not redundantly described herein. In comparison with the lateral-lighting type lighting device of FIG. 5, the plural LED units 91 of the lateral-lighting type lighting device 3′ of this embodiment are arranged between the lateral light source processing module 31 and the light guide module 32′. The light beams L2 emitted by the plural LED units 91 are firstly projected to the light guide module 32′. By the light guide module 32′, a great portion of the plural light beams L2 are guided to the saw-toothed structures 311 of the lateral light source processing module 31.

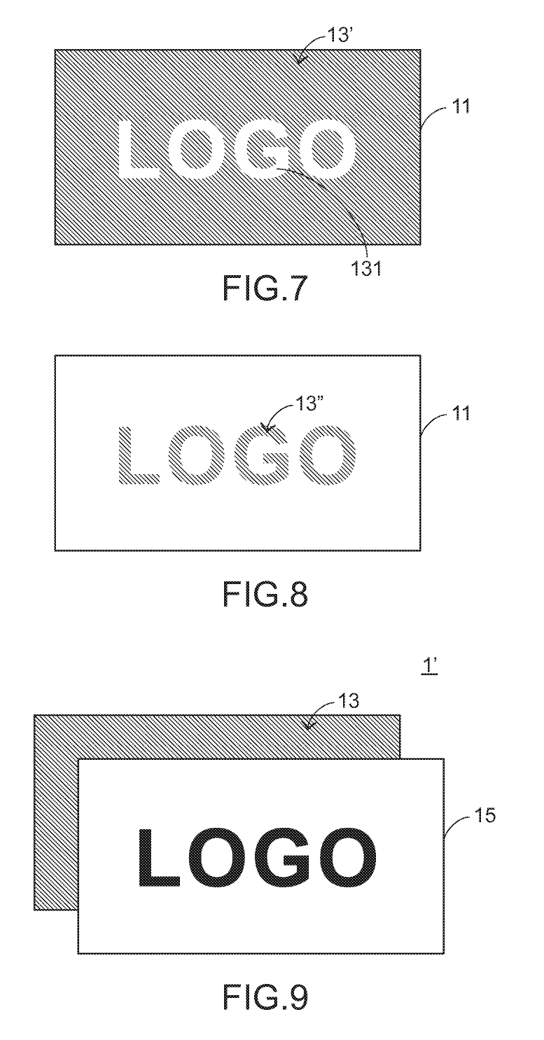

FIG. 7 is a schematic front view illustrating an exemplary speckle layer used in a diffusion structure according to a second embodiment of the present invention. Except that the speckle layer 13′ further comprises a functional region 131, the other components of the diffusion structure are similar to those of the diffusion structure 1 of the first embodiment, and are not redundantly described herein. In this embodiment, no speckle is included in the functional region 131. Moreover, the functional region 131 has a specified profile. For example, the functional region 131 is denoted as a word “LOGO”. In other words, the speckles of the speckle layer 13′ are not distributed over the entire first surface 11.

Since the functional region 131 has no any speckle, the functional region 131 fails to provide the light mixing function. Under this circumstance, the specified profile (e.g. “LOGO”) exhibits the rainbow-like colorful effect. Moreover, since the region of the speckle layer 13′ excluding the specified profile (e.g. “LOGO”) has the speckles to provide the light mixing function, the light beams outputted from the region of the speckle layer 13′ excluding the specified profile (e.g. “LOGO”) are uniformly mixed white light.

It is noted that numerous modifications and alterations may be made while retaining the teachings of the second embodiment. For example, the diffusion structure with the speckle layer including the functional region may be applied to the bottom-lighting type lighting device or the lateral-lighting type lighting device.

FIG. 8 is a schematic front view illustrating an exemplary speckle layer used in a diffusion structure according to a third embodiment of the present invention. Except that the speckles of the speckle layer 13″ are distributed over a part of the first surface 11, the other components of the diffusion structure are similar to those of the diffusion structure 1 of the first embodiment, and are not redundantly described herein. Moreover, the speckles of the speckle layer 13″ are distributed in a specified profile. For example, the speckle layer 13″ is denoted as a word “LOGO”.

Since the region of the speckle layer 13″ with the specified profile (e.g. “LOGO”) has the speckles to provide the light mixing function, the light beams outputted from the speckle layer 13″ are uniformly mixed white light. Moreover, since the region of the first surface 11 excluding the specified profile (e.g. “LOGO”) has no any speckle, the light mixing function fails to be provided. Under this circumstance, the region of the first surface 11 excluding the specified profile (e.g. “LOGO”) exhibits the rainbow-like colorful effect.

It is noted that numerous modifications and alterations may be made while retaining the teachings of the third embodiment. For example, the diffusion structure with the speckle layer distributed over a part of the first surface may be applied to the bottom-lighting type lighting device or the lateral-lighting type lighting device.

From the second embodiment and the third embodiment, by the diffusion structure 1 of the present invention, a specified region or a specified profile can attract people's attention in different ways or color effects. As a consequence, the diffusion structure of the present invention can provide an advertising effect or a special effect.

FIG. 9 is a schematic front view illustrating some components of a diffusion structure according to a fourth embodiment of the present invention. Except that the diffusion structure 1′ further comprises an image piece 15 (e.g. a positive film, a color film, a slide or a transparency film), the other components of the diffusion structure are similar to those of the diffusion structure 1 of the first embodiment, and are not redundantly described herein. Moreover, the image piece 15 is located at an outer side of the speckle layer 13, and arranged in the optical path of the light beams. Consequently, the light beams emitted by the light source are sequentially transmitted through the grating layer 14, the speckle layer 13 and the image piece 15 to exhibit the image of the image piece 15. As shown in FIG. 9, a portion of the image piece 15 (e.g. the specified profile “LOGO”) exhibits the red color, but another portion of the image piece 15 (e.g. the region excluding the specified profile “LOGO”) exhibits the green color. As a consequence, the diffusion structure of this embodiment can provide an advertising effect or a special effect.

It is noted that numerous modifications and alterations may be made while retaining the teachings of the fourth embodiment. For example, the diffusion structure with the image piece may be applied to the bottom-lighting type lighting device or the lateral-lighting type lighting device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lighting device, comprising:
at least one LED unit for emitting plural light beams; and
a diffusion structure arranged in a transmission path of said plural light beams, wherein said diffusion structure comprises a grating layer and a speckle layer, wherein said plural light beams are sequentially transmitted through said grating layer and said speckle layer and then outputted to surroundings.

2. The lighting device according to claim 1, wherein said grating layer is arranged between said at least one LED unit and said speckle layer.

3. The lighting device according to claim 1, wherein said speckle layer and said grating layer are formed on a first surface and a second surface of said diffusion structure, respectively.

4. The lighting device according to claim 3, wherein said grating layer comprises plural gratings, which are partially or entirely distributed over said second surface, wherein any two of said gratings have an identical grating parameter set or different grating parameter sets.

5. The lighting device according to claim 4, wherein said grating parameter set includes at least one of a grating depth, a grating pitch, a grating duty cycle and a grating orientation, wherein after said plural light beams are transmitted through said speckle layer and then outputted to surroundings, said plural light beams collectively result in a light pattern, wherein said light pattern is determined according to said grating parameter sets of said plural grating and/or a distribution status of said plural gratings.

6. The lighting device according to claim 3, wherein said speckle layer further comprises at least one functional region and said at least one functional region has a specified profile without any speckle, or said speckle layer is partially or entirely distributed over said first surface and at least comprises plural speckles, wherein said plural speckles are continuously distributed over said first surface, or said plural speckles are discontinuously distributed over said first surface, or said plural speckles are distributed as a specified profile, wherein any two of said plural speckles have an identical intensity, or any two of said plural speckles have different intensities.

7. The lighting device according to claim 1, wherein said grating layer is formed on said diffusion structure by at least one of a holographic lithography technology, an electronic etching technology, a laser beam writing technology, a phase mask lithography technology, a micro-molding technology and a holographic technology.

8. The lighting device according to claim 1, wherein said lighting device is a bottom-lighting type lighting device.

9. The lighting device according to claim 8, further comprising a lateral light source processing module and a light guide module, wherein at least one saw-toothed structure is formed on a second surface of said lateral light source processing module, and an included angle between a surface of said at least one saw-toothed structure and a normal line perpendicular to a first surface of said lateral light source processing module is a specified angle, wherein when at least one light beam is projected on said at least one saw-toothed structure, said at least one light beam is reflected by said at least one saw-toothed structure and propagated along a specified direction, so that said at least one light beam is transmitted through said first surface of said lateral light source processing module and directed to said diffusion structure, wherein said light guide module is arranged between said at least one LED unit and said lateral light source processing module, or said at least one LED unit is arranged between said lateral light source processing module and said light guide module, and at least one of said plural light beams from said at least one LED unit is guided to said at least one saw-toothed structure by said light guide module.

10. The lighting device according to claim 9, wherein said specified angle is in a range between 40 degrees and 45 degrees.

11. The lighting device according to claim 1, wherein said diffusion structure further comprises an image piece, and said speckle layer is arranged between said grating layer and said image piece, wherein said plural light beams from said at least one LED unit are sequentially transmitted through said grating layer, said speckle layer and said image piece and then outputted to surroundings.

12. A diffusion structure for uniformly diffusing plural light beams and outputting the plural light beams to surroundings, said diffusion structure comprising:
a first surface, wherein a speckle layer is formed on said first surface;
a second surface opposed to said first surface, wherein a grating layer is formed on said second surface,
wherein said grating layer is arranged between a light source and said speckle layer, so that said plural light beams emitted by said light source are sequentially transmitted through said grating layer and said speckle layer and then outputted to surroundings.

13. The diffusion structure according to claim 12, wherein said grating layer comprises plural gratings, which are partially or entirely distributed over said second surface, wherein any two of said gratings have an identical grating parameter set or different grating parameter sets.

14. The diffusion structure according to claim 13, wherein said grating parameter set includes at least one of a grating depth, a grating pitch, a grating duty cycle and a grating orientation, wherein after said plural light beams are transmitted through said speckle layer and then outputted to surroundings, said plural light beams collectively result in a light pattern, wherein said light pattern is determined according to at least one of said grating parameter sets of said plural grating and a distribution status of said plural gratings.

15. The diffusion structure according to claim 12, wherein said grating layer is formed on said diffusion structure by at least one of a holographic lithography technology, an electronic etching technology, a laser beam writing technology, a phase mask lithography technology, a micro-molding technology and a holographic technology.

16. The diffusion structure according to claim 12, wherein said speckle layer further comprises at least one functional region and said at least one functional region has a specified profile without any speckle, or said speckle layer is partially or entirely distributed over said first surface and at least comprises plural speckles, wherein said plural speckles are continuously distributed over said first surface, or said plural speckles are discontinuously distributed over said first surface, or said plural speckles are distributed as a specified profile, wherein any two of said plural speckles have an identical intensity, or any two of said plural speckles have different intensities.

17. The diffusion structure according to claim 12, wherein said diffusion structure is included in an indoor lighting device, an outdoor lighting device, a display device, a backlight module or a projecting device, or said light source comprises at least one LED unit.

18. The diffusion structure according to claim 17, wherein said indoor lighting device or said outdoor lighting device comprises a lateral light source processing module and a light guide module, wherein at least one saw-toothed structure is formed on a second surface of said lateral light source processing module, and an included angle between a surface of said at least one saw-toothed structure and a normal line perpendicular to a first surface of said lateral light source processing module is a specified angle, wherein when at least one light beam is projected on said at least one saw-toothed structure, said at least one light beam is reflected by said at least one saw-toothed structure and propagated along a specified direction, so that said at least one light beam is transmitted through said first surface of said lateral light source processing module and directed to said diffusion structure, wherein said light guide module is arranged between said at least one LED unit and said lateral light source processing module, or said at least one LED unit is arranged between said lateral light source processing module and said light guide module, and at least one of said plural light beams from said at least one LED unit is guided to said at least one saw-toothed structure by said light guide module.

19. The diffusion structure according to claim 18, wherein said specified angle is in a range between 40 degrees and 45 degrees.

20. The diffusion structure according to claim 12, further comprising an image piece, wherein said speckle layer is arranged between said grating layer and said image piece, wherein said plural light beams from said light source are sequentially transmitted through said grating layer, said speckle layer and said image piece and then outputted to surroundings.
